(19) United States
(12) Patent Application Publication
(10) Pub. No.: US 2009/0196589 A1
(43) Pub. Date: Aug. 6, 2009

(54) CAMERA WITH DOUBLE CASSETTE FILM SYSTEM

(75) Inventor: Yet Chan, Kowloon (HK)

Correspondence Address: AKERMAN SENTERFITT, P.O. BOX 3188, WEST PALM BEACH, FL, 33402-3188, US

(73) Assignee: Foster Assets Corporation, Tortola (VG)

(21) Appl. No.: 12/024,942

(22) Filed: Feb. 1, 2008

(51) Int. Cl. G03B 17/02

(52) U.S. Cl. 396/6

(57) ABSTRACT

Aspects of the invention are directed to a camera with double cassette system (DCS) film. The camera and DCS film are configured to allow only a specific type of DCS film to be used in the camera and to prevent reuse of the secondary cassette of the DCS film. To such end, the second chamber of the camera can include one or more protrusions therein. The protrusions can extend from the upper and lower end walls of the second chamber. In one embodiment, there is a first protrusion associated with the upper end wall and a second protrusion associated with the lower end wall. In order to properly set in the second chamber, a secondary cassette of a DCS film system includes recesses that can receive at least a portion of a respective protrusion. To prevent reuse of the secondary cassette, it constituent shells can be welded together.

### FIELD OF THE INVENTION

The invention relates in general to film cameras and, more particularly, to camera structure and methods for dictating the use of a particular film system for a camera.

### BACKGROUND OF THE INVENTION

In recent years, cameras known as disposable cameras, single-use cameras or lens-fitted photographic film packages have become increasingly popular. Such cameras are of relatively simple construction and are sold at a low cost. In addition, these types of cameras are usually pre-loaded with film by the manufacturer. Some of these cameras use a film system referred to as a Double Cassette System or “DCS,” which is well known in the art. Examples of a DCS film system are discussed in U.S. Pat. Nos. 7,181,133; 7,039,306; 6,789,961; 6,785,467; 6,763,184; 6,447,176 and 6,427,050.

One example of a DCS-type film system 2 is shown in FIG. 1. The DCS film 2 can include a primary cassette or cartridge 4, which can be a standard 35 millimeter cartridge 6, and a secondary cassette or cartridge 8. The secondary cassette 8 does not have a spool. With a new DCS film assembly 2, a substantial portion of the film 10 is already wound into a roll in the secondary cassette 8. As pictures are taken, the film 10 can be wound frame by frame out of the secondary cassette 8 and back into the 35 millimeter cartridge 6.

DCS film 2 is advantageous because manufacturers and consumers alike can conveniently load it into a camera in the daylight or under otherwise normal lighting conditions. Also, the DCS film 2 can be simply inserted into a camera without the need for further manipulation of the film 10, such as winding the film out of the primary cassette 4 or attaching a film leader to a spool. Likewise, no film rewinding is required after all of the pictures are taken because all of the film will have been wound back into the light-tight primary cassette 4.

A user can remove the 35 millimeter cassette 6 from the camera and take it to a photo processor, while keeping the camera body. In such case, the user can reload the empty camera body with a fresh roll of film. More commonly, a user gives the entire camera to a photo processor to develop the pictures.

Photo processors typically collect the empty camera bodies and film system components, like secondary cassettes, for resale. Purchasers of such components typically reload and/or repackage them and sell them as new cameras or new DCS film systems. As a result of such activities, the original manufacturer's revenues can decline because its own cameras or film systems are being resold, usually at a fraction of the price. Moreover, such activities can generate ill perceptions in the minds of consumers toward the original manufacturer if the reloaded cameras and film systems are poorly assembled or exhibit poor performance because such some of the components of such reloaded cameras often bear the markings of the original manufacturer.

Thus, there is a need for a camera assembly and film system that can discourage or prevent such activities.

### SUMMARY OF THE INVENTION

In a first aspect, embodiments of the invention are directed to a camera. The camera has a main body supporting a taking lens and a closeable exposure aperture. The main body has a cartridge chamber and a film chamber disposed on opposite sides of the exposure aperture. The film chamber is defined at least in part by a concave curved wall bounded by an upper end wall and a lower end wall. The film chamber is sized to receive a secondary cassette of a double cassette film system. The film chamber includes a first protrusion extending into the film chamber from either the concave curved wall, the upper end wall or the lower end wall. In one embodiment, the first protrusion can extend from either the upper wall or the lower wall. A back cover operatively engages the main body to enclose the chambers light-tightly therein.

A second protrusion can extend into the film chamber from either the concave curved wall, the upper end wall or the lower end wall. In one embodiment, the first protrusion can extend from the upper end wall, and the second protrusion can extend from the lower end wall. The first and second protrusions can be substantially identical. However, the size and/or shape of the first protrusion can be different from the second protrusion. The first and second protrusions can be substantially vertically aligned. The first and second protrusions can both be located in a right side region of the film chamber.

In a second aspect, embodiments of the invention are directed to a double cassette film system. The system includes a primary cassette, which can be a 35 millimeter cassette. The system also includes a secondary cassette. The secondary cassette has an exterior defined by an upper end wall, a lower end wall, and a curved middle wall. The secondary cassette includes a first recess formed in the exterior of the secondary cassette. In one embodiment, the first recess can be formed in one of the upper and lower end walls.

A second recess can be formed in the exterior of the second cassette. In such case, the first recess can be formed in the upper end wall, and the second recess can be formed in the lower end wall. The first and second recesses can be substantially the same size and/or can have substantially the same shape. In some instances, the first and second recesses can be different in size and/or shape.

The secondary cassette can be formed by a first partial shell and a second partial shell. In one embodiment, the first and second partial shells can be permanently coupled, such as by being welded together. As a result, the secondary cassette must be broken in order to be opened. In another embodiment, the first and second partial shells can be connected by lugs engaging respective openings.

The system also includes photographic film. A first portion of the photographic film is light-tightly housed within the primary cassette, and a second portion of the photographic film is light-tightly housed within the secondary cassette. A third portion of the photographic film extends between the primary and secondary cassettes. The third portion of film is located between the first and second portions of film.

In a third aspect, embodiments of the invention are directed to a camera system, including a camera and a double cassette film system. The camera has a main body with a closeable exposure aperture, a cartridge chamber and a film chamber disposed on opposite sides of the aperture. The film chamber is defined at least in part by a concave curved wall bounded by an upper end wall and a lower end wall. The film chamber is sized to receive a secondary cassette of a double cassette film system. The film chamber includes a first protrusion extending into the film chamber from either the concave curved wall, the upper end wall or the lower end wall.

The double cassette film system includes a primary cassette and a secondary cassette. The secondary cassette has an exterior defined by an upper end wall, a lower end wall, and a curved middle wall. The secondary cassette includes a first recess formed in the exterior of the secondary cassette. The double cassette film system also includes photographic film. A first portion of the photographic film is light-tightly housed within the primary cassette, and a second portion of the photographic film is light-tightly housed within the secondary cassette. A third portion of the photographic film extends between the primary and secondary cassettes. The third portion of film is located between the first and second portions of film.

The primary cassette is received in the cartridge chamber, and the secondary cassette is received in the film chamber such that at least a portion of the first protrusion extends into the first recess. The camera can includes a back cover that operatively engages the main body to enclose the double cassette film system light-tightly therein.

The first protrusion can extend from either the upper wall or the lower wall of the film chamber. In such case, the first recess can be formed in a respective one of the upper and lower end wall of the secondary cassette. In one embodiment, the camera system can further include a second protrusion extending into the film chamber from either the concave curved wall of the film chamber, the upper end wall or the lower end wall. In addition, a second recess can be formed in the exterior of the secondary cassette. In such case, at least a portion of the second protrusion can extend into the second recess.

In one embodiment, the first protrusion can extend from the upper end wall of the film chamber, and the second protrusion can extend from the lower end wall of the film chamber. The first recess can be formed in the upper end wall of the secondary cassette, and the second recess can be formed in the lower end wall of the secondary cassette.

In a fourth aspect, embodiments are directed to a method of making a film system. The method involves withdrawing a length of film from a film source. A portion of the length of film is formed into a roll. The forming step can be performed by the steps of: (a) attaching an end of the withdrawn length of film to a shaft, (b) rotating the shaft so that the film winds around the shaft in the form of a roll and (c) separating the shaft and the film roll. A portion of the film extends from the roll.

A first partial shell and a second partial shell are brought together around the roll of film so as to light-tightly enclose the film inside and so that the portion of film extends outside of the first and second partial shells. As a result, a secondary cassette having an exterior is formed. A recess is formed in the exterior of the secondary cassette. The above-described steps of withdrawing, forming and bringing together are performed in a dark environment, which can be a dark room. The method can include the further step of permanently coupling the first and second partial shells, which can be preformed by supersonic welding.

In one embodiment, the film source can be a 35 millimeter film cartridge. In another embodiment, the film source can be a film pancake. In such case, the method can further include the step of cutting the length of film from the film pancake. The cut length of film can have a trailing end. A light-tight primary cassette can be provided. The primary cassette can have an internal spool and a film slot. The trailing end of film can be inserted into the primary cassette through the film slot and attached to the internal spool.

In a fifth respect, embodiments of the invention are directed to a method of loading film in a camera. According to the method, a camera is provided that has a main body with a closeable exposure aperture, a cartridge chamber and a film chamber disposed on opposite sides of the aperture. The film chamber is defined at least in part by a concave curved wall bounded by an upper end wall and a lower end wall. The film chamber is sized to receive a secondary cassette of a double cassette film system. The film chamber includes a first protrusion extending into the film chamber from either the concave curved wall, the upper end wall or the lower end wall.

A double cassette film system is provided, and it includes a primary cassette and a secondary cassette. The secondary cassette has an exterior defined by an upper end wall, a lower end wall, and a curved middle wall. The secondary cassette includes a first recess formed in the exterior of the secondary cassette. The double cassette film system also includes photographic film. A first portion of the photographic film is light-tightly housed within the primary cassette, and a second portion of the photographic film is light-tightly housed within the secondary cassette. A third portion of the photographic film extends between the primary and secondary cassettes. The third portion of film is located between the first and second portions of film.

The primary cassette of the DCS film is inserted into the cartridge chamber. The secondary cassette of the DCS film is inserted into the film chamber such that the first protrusion is at least partially received in the first recess in the secondary cassette. The steps of inserting the primary cassette and inserting the secondary cassette can be performed substantially simultaneously. Alternatively, the step of inserting the primary cassette can be performed prior to the step of inserting the secondary cassette. In another alternative embodiment, the step of inserting the secondary cassette can be performed prior to the step of inserting the primary cassette. The above providing and inserting steps can be performed in normal light conditions.

The camera can include a back cover. In such case, the method can further include the step of operatively engaging the back cover and the main body so as to enclose the double cassette film system light-tightly therein.

### BRIEF DESCRIPTION OF THE DRAWINGS

FIG. 1 is a perspective view of known DCS film system.

FIG. 2 is a partially exploded perspective view of a camera with a film receiving chamber configured in accordance with aspects of the invention.

FIG. 3 is a perspective view of a DCS film system with a secondary cassette configured in accordance with aspects of the invention.

FIG. 4 is an exploded view of a secondary cassette configured in accordance with aspects of the invention, showing a first partial shell and a second partial shell.

FIG. 5 is a side elevational view of a method according to aspects of the invention, showing a length of film being withdrawn from a film pancake.

FIG. 6 is top plan view of a method according to aspects of the invention, showing a cut length of film from the pancake.

FIG. 7 is a perspective view of a method according to aspects of the invention, showing attachment of a trailing end of the film being attached to the winding shaft of a spooling device.

FIG. 8 is a perspective view of a method according to aspects of the invention, showing the winding shaft being used to wind the film into a roll.

FIG. 9 is a perspective view of a method according to aspects of the invention, showing the winding shaft being withdrawn from the film roll.

FIG. 10 is a perspective view of a method according to aspects of the invention, showing the film roll being removed from the spooling device.

FIG. 11 is a perspective view of a method according to aspects of the invention, showing the film roll being enclosed in two partial shells to form a secondary cassette.

FIG. 12 is a perspective view of a method according to aspects of the invention, showing the two partial shells being permanently coupled by supersonic welding.

FIG. 13 is a perspective view of a method according to aspects of the invention, showing a leading end of the film roll in the secondary cassette being inserted into the primary cassette using a film guide.

FIG. 14 is a perspective view of a method according to aspects of the invention, showing the film guide being withdrawn after the leading end of the film is attached to the spool inside the primary cassette.

FIG. 15 is a perspective view of a film loading method of loading in accordance with aspects of the invention, showing the DCS film being inserted into the main body of an open camera.

FIG. 16 is a perspective view of a film loading method of loading in accordance with aspects of the invention, showing an endcap and a battery door being attached to the camera body.

FIG. 17 is a perspective view of a film loading method of loading in accordance with aspects of the invention, showing the back cover of the camera being closed.

FIG. 18 is a perspective view of a film loading method of loading in accordance with aspects of the invention, showing the completed camera.

FIG. 19 is a perspective view of a camera in accordance with aspects of the invention, showing the removal of the primary and secondary cassettes after all pictures have been taken.

### DETAILED DESCRIPTION OF EMBODIMENTS OF THE INVENTION

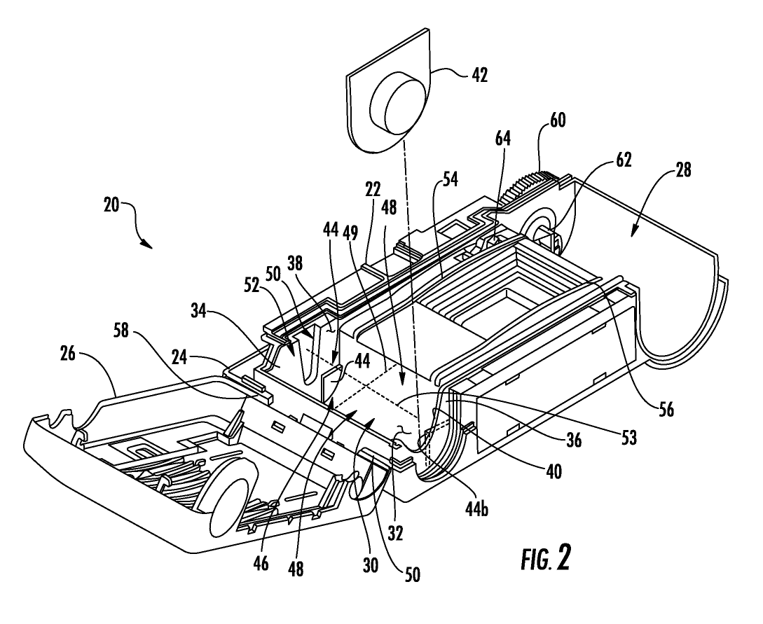

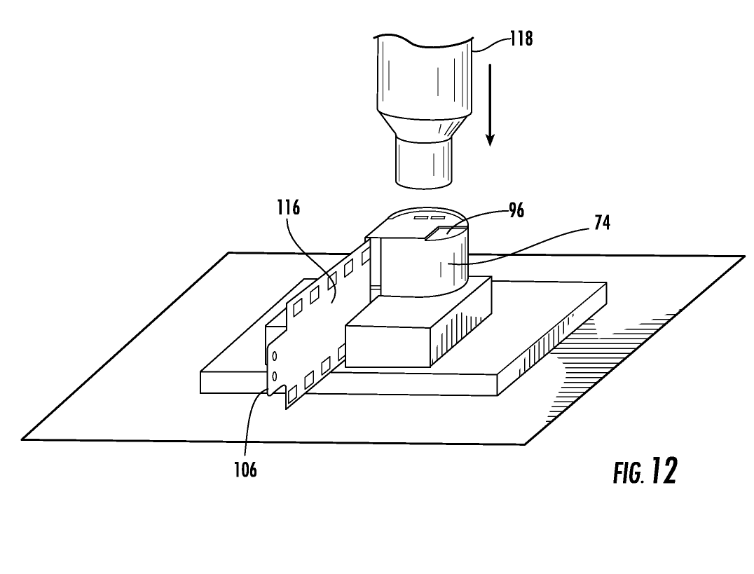

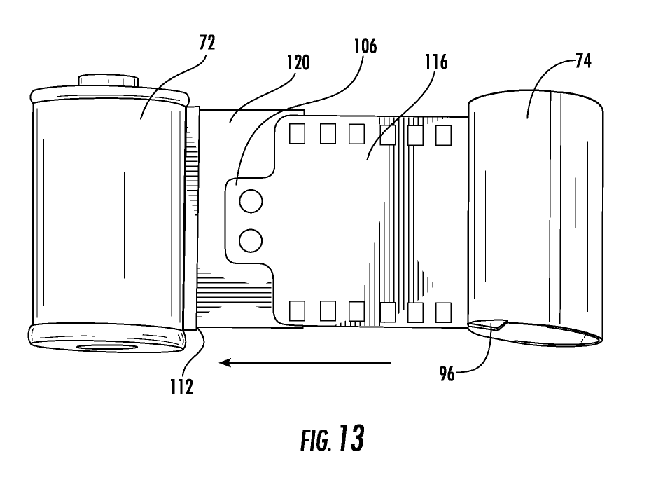

Aspects of the present invention relate to camera assemblies and associated methods of loading such camera assemblies that can discourage or prevent others from reusing. Embodiments according to aspects of the invention are shown in FIGS. 2-19, but the present invention is not limited to the illustrated structure or application. Further, the following detailed description is intended only as exemplary.

In one respect, embodiments of the invention are directed to a camera assembly. An example of a camera assembly 20 in accordance with aspects of the invention is shown in FIG. 2. The camera assembly 20 can include a main body 22, a front cover 24 and back cover 26. In some embodiments, there may not be a front cover 24. The main body 22 can carry a majority of the operative components of the camera 20. The main body 22 can support a taking lens assembly (not shown), a front portion of which can extend through an aperture (not shown) in the front cover 24, and behind which is arranged a shutter assembly (not shown), as is well understood in the art.

A first chamber 28 can be defined at least in part by the main body 22 and the back cover 26. The first chamber 28 can receive a film-containing cassette or light-tight film cartridge, preferably a conventional 35 millimeter cartridge having a central rotatable spool on which the film is wound. With appropriate modification, other standard film formats can equally be accommodated within the first chamber 28. A second chamber 30 can be arranged on the opposite side of the camera 20 from the first chamber 28. Like the first chamber 28, the second chamber 30 can be defined at least in part by the main body 22 and the back cover 26. In one embodiment, the second chamber 30 can be adapted, shaped, sized, and/or otherwise configured to receive a secondary cassette housing a roll of film light-tightly therein, such as the secondary cassette a DCS film system, which is described later.

The second chamber 30 can include a concave curved surface 32 of the main body 22, bounded on its upper and lower ends by upper and lower end walls 34, 36, respectively. The terms “upper” and “lower” are used to indicate the relative position of the end walls 34, 36 of the second chamber 30 when the camera assembly 20 is held in its normal operational position. These terms are used to facilitate discussion and are not intended to limit the scope of the invention. The upper and lower end walls 34, 36 can each have a respective interior surface 38, 40, respectively. The interior surfaces 38, 40 face the inside of the second chamber 30. The interior surfaces 38, 40 can be generally parallel to each other. In one embodiment, the interior surfaces 38, 40 can be substantially smooth, substantially flat and/or substantially planar. However, as will be discussed below, the interior surfaces 38, 40 can have localized areas that are not smooth, flat and/or planar.

It should be noted that, in some instances, the lower end of the second chamber 30 can include an endcap 42, which can cooperate with other components to ensure the camera 20 is light-tight. The endcap 42 can be removably attached to the main body 22. Alternatively, the endcap 42 can be permanently attached to the main body 22. In some cameras, an endcap 42 may not be necessary if the lower end wall 36 is sufficiently large. Some examples of an endcap are disclosed in U.S. Pat. No. 7,181,133, which is incorporated herein by reference.

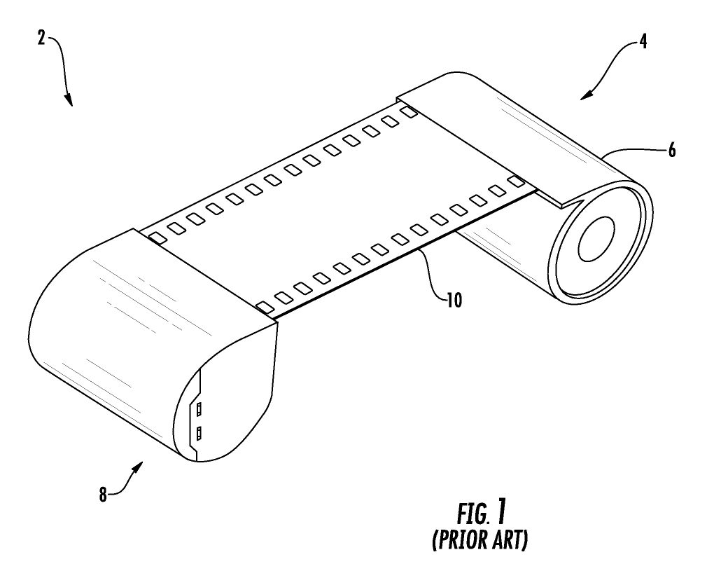

According to aspects of the invention, the second chamber 30 can include one or more features that only permit the installation of a particular DCS film system. For instance, the second chamber 30 can include one or more protrusions 44. The protrusions 44 can have any suitable size. The protrusions 44 must be sufficiently large to prevent a known secondary cassette (FIG. 1) from seating properly in the second chamber 30. The protrusions 44 can have any suitable shape, including, for example, circular, semi-circular, quarter-circular, oval, polygonal, triangular, trapezoidal, and combinations thereof, just to name a few possibilities.

The protrusions 44 can extend from any surface of the second chamber 30, including the curved surface 11 of the main body 4, the interior surface 38 of the upper end wall 34, the interior surface 40 of the lower end wall 36 and/or the endcap 42. The protrusions 44 can extend from one or more of these surfaces at any suitable angle. The protrusions 44 can be formed together with the second chamber 30, such as during the molding process, so as to form a unitary structure. Alternatively, the protrusions 44 can be subsequently added to the second chamber 30, such as by fasteners, adhesives, welding, mechanical engagement and/or other suitable process.

Any suitable quantity of protrusions 44 can be provided. In one embodiment, there can be a single protrusion 44. In one embodiment, there can be at least two protrusions 44. The protrusions 44 can be located in any suitable area of the second chamber 30. In one embodiment, there can be two protrusions 44, preferably located in opposite regions of the second chamber 30. More particularly, a first protrusion 44a can be located in an upper region 46 of the second chamber 30, and a second protrusion 44b can be located in a lower region 48 of the second chamber 30. Here, the terms “upper region” and “lower region” are used to indicate a relative position in the second chamber 30 when the camera assembly 20 is held in its normal operational position and is divided substantially equally by an imaginary horizontal plane 49.

In one embodiment, the first protrusion 44a can project from the interior surface 38 of the upper end wall 34, and the second protrusion 44b can project from the interior surface 40 of the lower end wall 36. More particularly, the first and second protrusions 44a, 44b can be located in one of a right side region 50 and a left side region 52 of the second chamber 30. The terms “right” and “left” are used to indicate a relative position in the second chamber 30 when the camera assembly 20 is held in its normal operational position and is divided substantially equally by an imaginary vertical plane 53. The first and second protrusions 44a, 44b can be substantially aligned. In one embodiment, the first and second protrusions 44a, 44b can be substantially vertically aligned. Alternatively, the first and second protrusions 44a, 44b can be substantially horizontally aligned. The terms “horizontal” and “vertical” are intended to indicate a relative position in the second chamber 30 when the camera assembly 20 is held in its normal operational position.

Again, the above-described arrangement is provided merely as an example, and aspects of the invention are not limited to any particular arrangement. For instance, the first and second protrusions 44a, 44b can both be located in the same region—upper, lower, left, right—of the second chamber 30. Further, there need not be any particular symmetry or alignment to the arrangement of the first and second protrusions 44a, 44b. For instance, the first protrusion 44a and the second protrusion 44b can be offset from each other. The first and second protrusions 44a, 44b can also extend from different surfaces, in different directions and at different angles. The first and second protrusions 44a, 44b can be substantially identical in size and shape, but, in some instances, the first and second protrusions 44a, 44b can be different from each other in at least one of these respects.

The camera assembly 20 can have an exposure window (not shown), which can be arranged between the first and second film chambers 28, 30 and located between an upper guide rail 54 and a lower film guide rail 56, which support the film at its edges as it extends between the film chambers 28, 30. A film passageway for the film to travel between the film chambers 28, 30 can be defined between the back cover 26 and opposed regions of the main body 22 and film guides 54, 56.

The back cover 26 can be associated with the rest of the camera assembly 20 in any of a number of ways, as will be appreciated by one skilled in the art. For example, in one embodiment, the back cover 26 can be removably fitted to the main body 22. In one embodiment, the removable connection can be achieved by providing at opposite edges a pair of protrusions (not shown) on the main body 22 which snap-fit into apertures (not shown) provided on the back cover 26. The back cover 26 can also be provided with releasable locking means or a latch including a pair of finger slides (not shown) having an inwardly directed movable pin (not shown) on the back cover 26. The finger slides can be movable between an open position, where the back cover 26 can be simply push-fitted on to the rear of the main body 22 with the pin extending into a recess formed on the main body 22, and a locking position where the pin engages beneath a lug molded on the main body 22. These arrangements allow the user to readily open and close the camera for re-loading films therein.

In one embodiment, the back cover 26 can be retainably attached to the front cover 24 and/or main body 22. For example, one end of the back cover 26 can be attached to one end of the front cover 24 by one or more hinges 58. The opposite unhinged ends of the front and back covers 24, 26 can be secured together in any of the manners discussed above. There are still many other ways of removably securing the back cover 26 to the front cover 24 and/or main body 22, as will be appreciated by one skilled in the art. While embodiments of the invention are not limited to any particular manner of associating the back cover 26 with the rest of the camera assembly 20, the back cover 26 can operatively engage the main body 22 to enclose the chambers 28, 30 light-tightly therein.

As is conventional, the camera assembly 20 can be provided with a film advance system for winding the film back into the primary cassette or the conventional film cartridge. The system can include a film advance wheel or thumb wheel 60 rotatably attached to the main body 22. The film advance system can also include a drive shaft 62 operatively connected to the thumb wheel 30. The drive shaft 62 can extend into the first chamber 28. When a film cartridge is disposed in the first chamber 28, the drive shaft 62 can engage the central spool of the film cartridge. The film advance system can further include a film sprocket wheel 64 located just above the film exposure window, and a film counter (not shown). The film sprocket wheel 64 can be operatively connected to the re-cocking system of the shutter (not shown), so that each time the film is wound one frame by the user (by turning the film advance wheel), the film sprocket wheel 64 is rotated one turn, which brings a lever of the shutter back to its primed position, and in addition prevents further rotation of the film advance wheel 60. The film advance and shutter re-cocking systems are well known in the art, and embodiments of the invention are not limited to any particular configuration for either system.

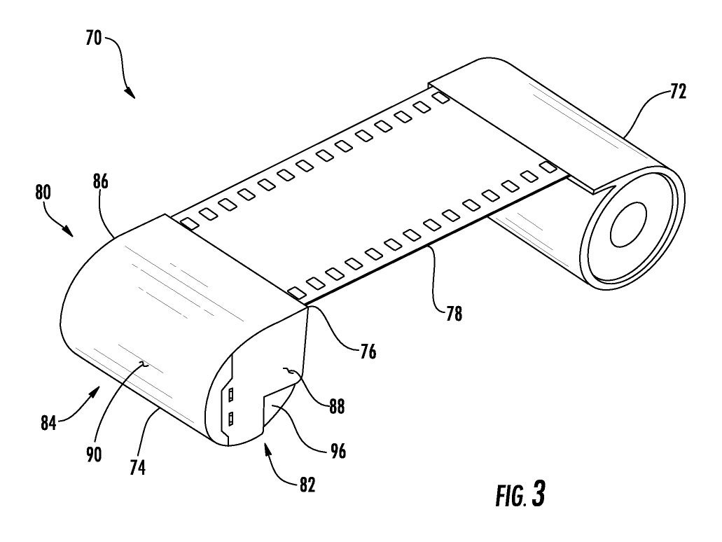

Now that the structure of the camera has been described, a film system for use in the camera will now be described. Aspects of the invention are particularly well suited for use with DCS film. One example of DCS film 70 is shown in FIG. 3. The DCS film 70 can include a primary cassette or cartridge 72, which can be a standard 35 millimeter cartridge, and a secondary cassette or cartridge 74. It should be noted that the terms “primary” and “secondary” are used for convenience to facilitate discussion and are not intended to limit the scope of the invention. In new DCS film 70, a substantial portion of the film 78 is wound in a roll in the secondary cassette 74. One end of the film 78 is attached to a spool (not shown) in the primary cassette 72.

The secondary cassette 74 can be of similar general shape to a conventional film cassette or to the primary cassette 72. However, in contrast to the primary cassette 72, the secondary cassette 74 has no spool. The secondary cassette 74 can include a film slot 76 through which the film 78 can extend. Preferably, the secondary cassette 74 is provided with light-sealing features, such as opposed strips of velvet or similar soft material around the film slot 76 and similar to what is used in a conventional film cassette. Preferably, the secondary cassette 74 is not identical in size or shape to the primary cassette 72. For instance, the secondary cassette 74 can be smaller in size than the primary cassette 72 in order to ensure that the user does not try to load the primary and secondary cassettes 72, 74 into the wrong film chambers 28, 30 in the camera assembly 20.

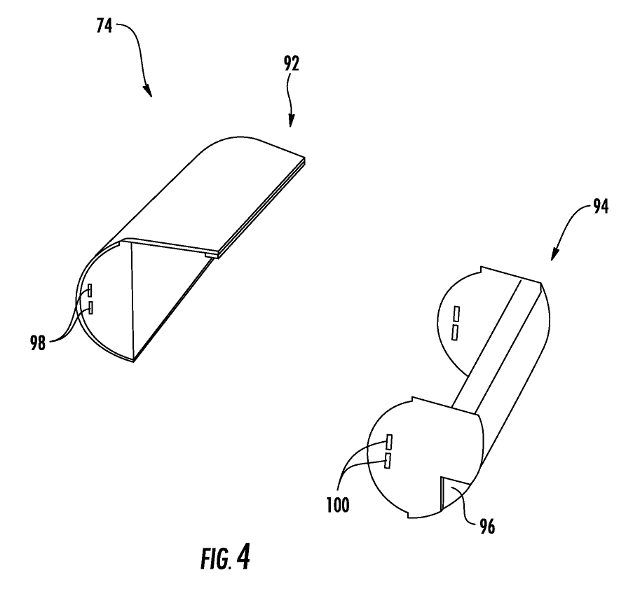

The secondary cassette 74 can be generally cylindrical in conformation with an upper end wall 80, a lower end wall 82 and a curved middle wall 84. The upper and lower end walls 80, 82 can have an associated external surface 86, 88, respectively. Likewise, the middle wall 84 can have an associated external surface 90. The secondary cassette 74 can be made of two partial shells—a first partial shell 92 and a second partial shell 94, as is shown in FIG. 4. In accordance with aspects of the invention, the first and second partial shells 92, 94 can be permanently coupled such that a user would have to break the secondary cassette 74 in order to open it. Such permanent coupling can be achieved by any suitable technique, such as, for example, supersonic welding. In addition to being permanent coupling, the first and second partial shells 92, 94 can be connected by mechanical engagement, such as snap-fitting and/or engaging lugs 98 and openings 100 (see FIG. 4). Because the first and second partial shells 92, 94 are permanently coupled, a subsequent reloader will be discouraged if not completely prevented from reusing the secondary cassette 74 and/or the first and second partial shells 92, 94.

According to aspects of the invention, the secondary cassette 74 can include one or more features in at least one of its external surfaces 86, 88, 90 for engagement with the protrusions 44 in the second chamber 30. For example, the secondary cassette 74 can have one or more recesses 96 in one of its external surfaces 86, 88, 90. Each recess 96 can receive at least a portion of a respective one of the protrusions 44 in the second chamber 30. To that end, the recesses 96 can be sized, shaped and located so as to substantially correspond to the size, shape and locations of the protrusions 44 in the second chamber 30 of the camera 20. In one embodiment, each recess 96 can be configured to substantially matingly engage a respective one of the protrusions 44. The recess 96 can be formed in the secondary cassette 30 as part of the process of molding the constituent first and second partial shells 92, 94. The provision of a recess 44 on an exterior surface of the secondary cassette 74 may result in a localized indentation on the interior surface of the secondary cassette 74 in that area. Such an indentation may be necessary due to manufacturing, structural and other concerns.

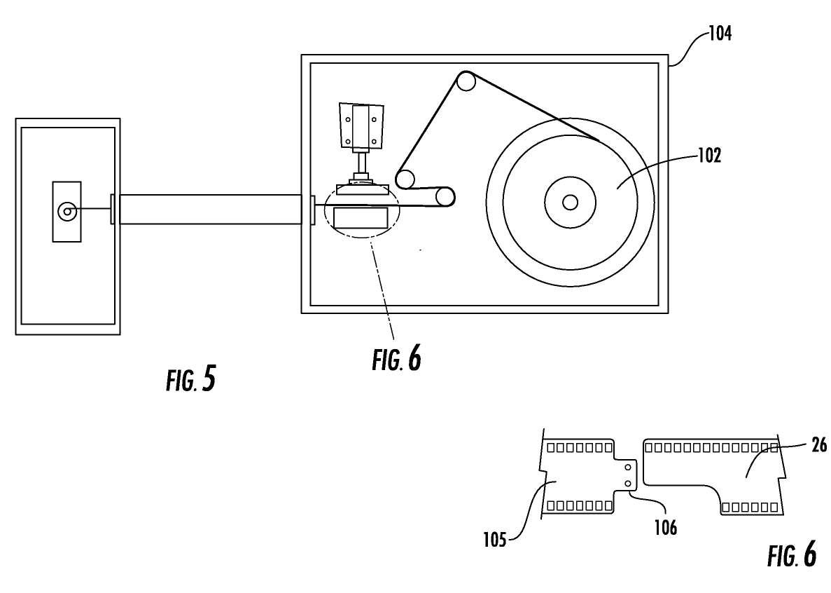

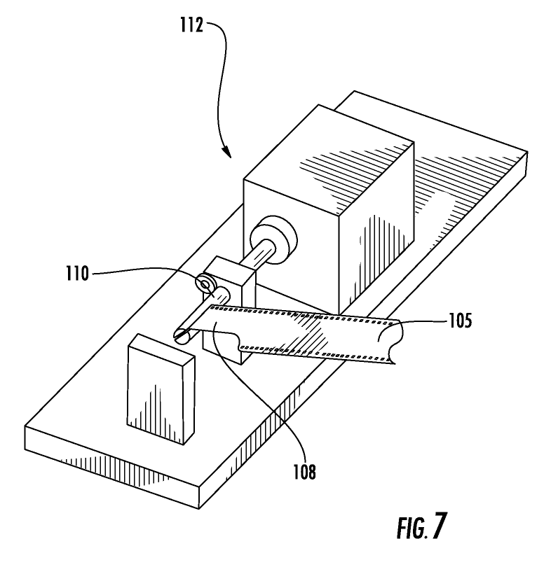

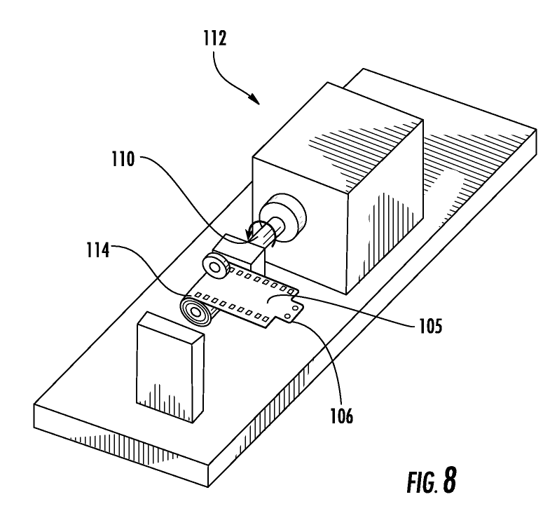

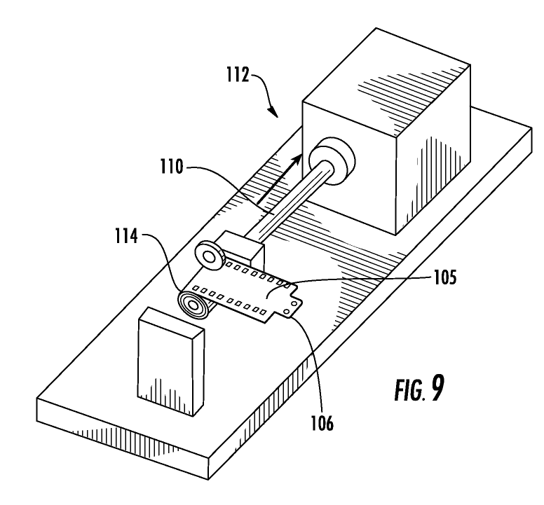

DCS film 70 configured in accordance with aspects of the invention can be formed in various ways. One method is shown in FIGS. 5-14. Unexposed film is provided in the form of a pancake 102 of film. A “pancake” is a term used in the art to describe a large bulk roll of unexposed film. It is to be distinguished from small rolls of unexposed film, such as a roll of film from a 35 mm cassette. Referring to FIG. 5, the pancake 102 is taken into a dark enclosure 104, such as a darkroom. A length of unexposed film is withdrawn from the pancake 102. The withdrawn film can be cut from the pancake. The cut length of film 105 can have a trailing end 106, as shown in FIG. 6. As shown in FIG. 7, a leading end 108 of the cut length of film 105 can be attached to the shaft 110 of a spooling device 112. The film 105 can be wound into a roll 114 around the shaft 110, as shown in FIG. 8. A portion of the film including the trailing end 106 can extend from the roll 114.

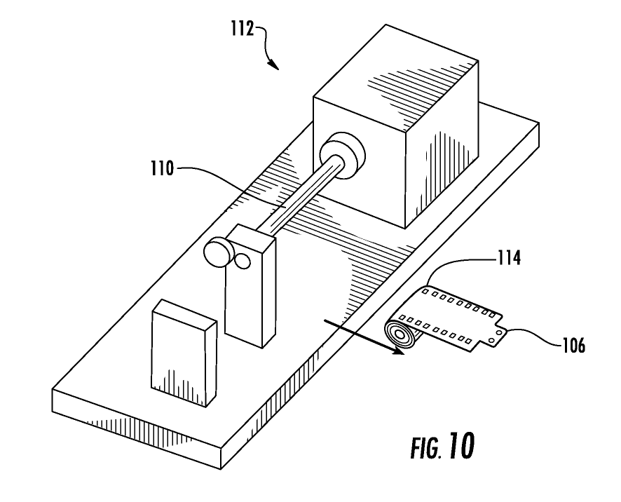

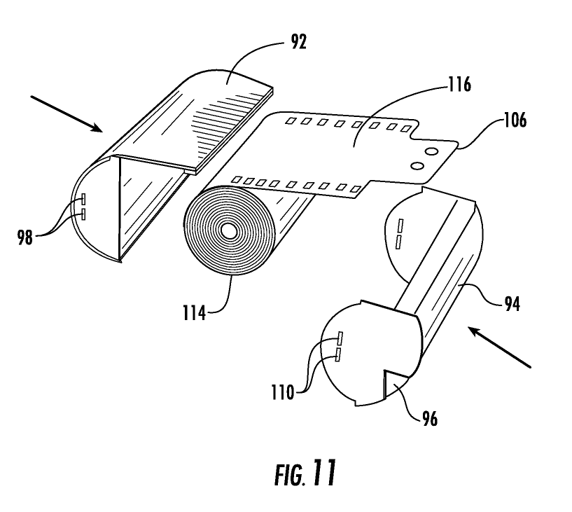

As shown in FIGS. 9 and 10, the winding shaft 110 can be withdrawn, and the film roll 114 can be removed from the spooling device 112. The first and second partial shells 92, 94 can be brought together around the unexposed roll of film 114 so as to light-tightly enclose the film 114 inside with a portion of film 116 including the trailing end 106 extending outside, thereby forming the secondary cassette 74. As noted above, the first and second partial shells 92, 94 can be held together by, for example engaging lugs 98 and openings 110. At least one of the shells 92, 94 can provide one or more recesses 96 in accordance with aspects of the invention. It should be noted that all of the above steps can be performed in a darkroom.

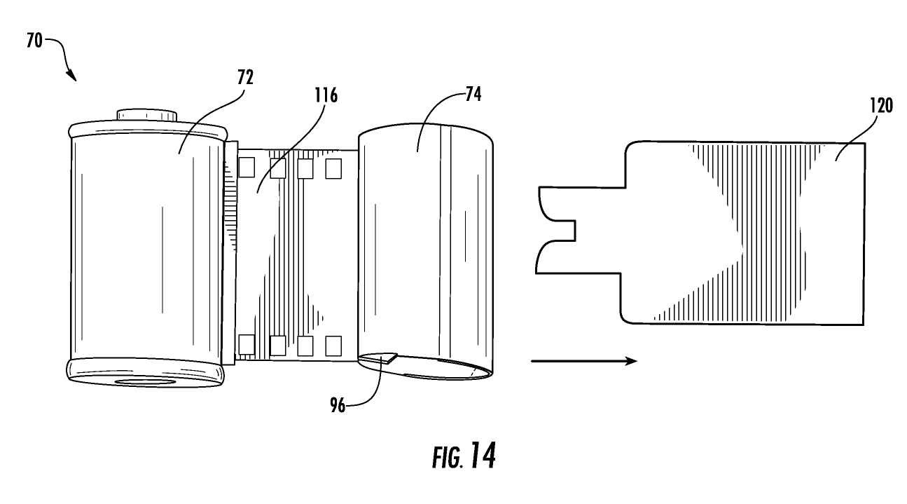

As noted earlier, the first and second partial shells 92, 94 can be permanently coupled together. To that end, a supersonic welding device 118 can be use to permanently couple the first and second partial shells 92, 94 together. As shown in FIG. 13, the trailing end 106 of film can be inserted through a film slot 112 into an empty primary cassette 72, such as a standard 35 mm cassette. This step can be performed in ordinary light conditions. The trailing end 106 can be secured to the spool (not shown) inside the primary cassette 72. A film guide 120 can be used to facilitate the insertion of the trailing end 106 into the primary cassette 72 and the attachment of the trailing end 106 to the internal spool. Upon completion of these steps, the film guide 120 can be removed, thereby forming a complete DCS film system 70, as shown in FIG. 14.

In an alternative embodiment, unexposed film can come from a different source. For example, unexposed film can be withdrawn initially from a 35 mm cartridge instead of a pancake in a dark enclosure. The withdrawn portion of film is formed in a roll. The first and second partial shells of the secondary cassette can be brought together around the unexposed roll of film so as to light-tightly enclose the film roll inside. All of the above steps can be performed in a darkroom. The first and second partial shells can be welded together. In this process, it should be noted that the trailing end of the film remains attached to the film spool of the 35 mm cartridge.

It will be understood that the above-described processes of making a DCS film assembly are merely examples. Aspects of the invention are not limited to the specific steps and details presented, including the order in which the steps are performed.

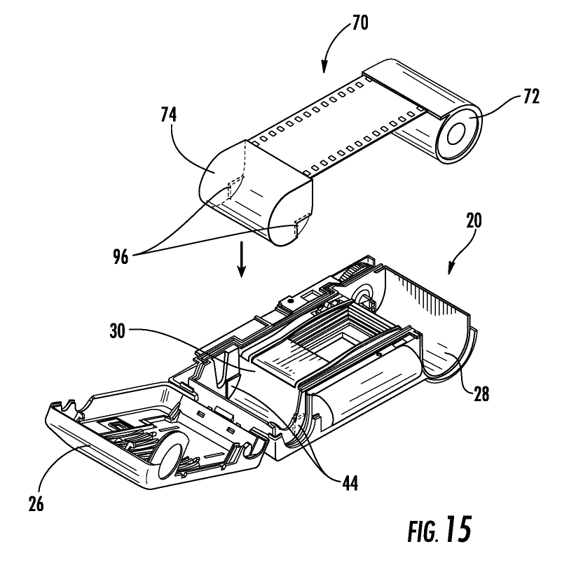

Having described the individual components and manner in which the DCS film can be made in accordance with aspects of the present invention, one illustrative manner in which DCS film 70 can be loaded into such the camera 20 will now be described in connection with FIGS. 15-18. The following description is merely an example of a sequence in which the individual loading steps can occur, and it is not intended to limit the scope of the invention to the exact method described, for not every step need occur. Further, the various steps do not necessarily need to be performed in the order set forth below.

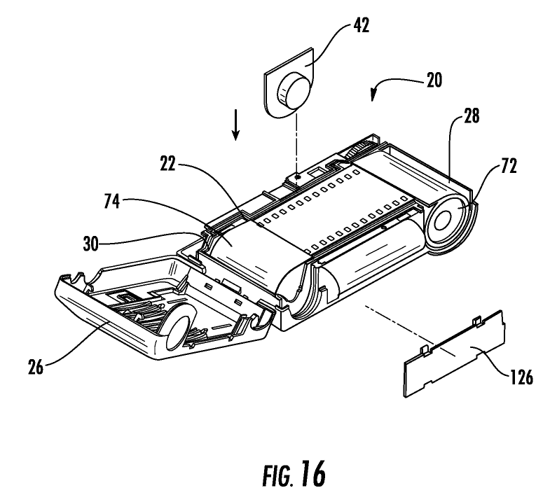

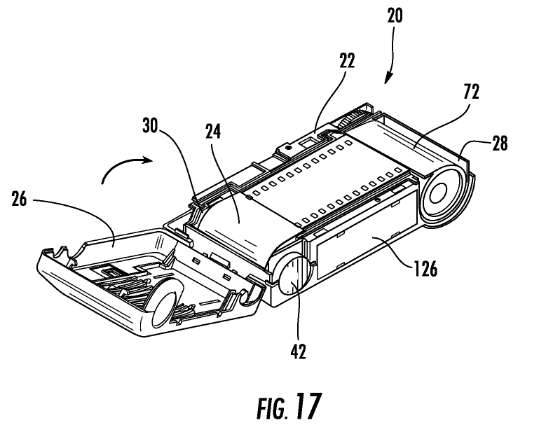

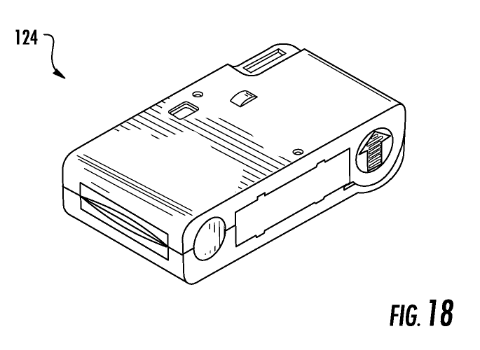

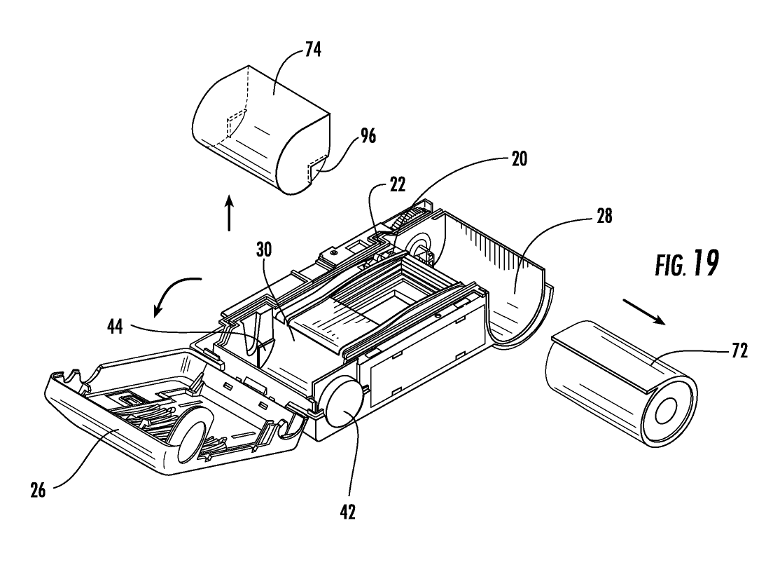

An empty camera 20 is provided with the back cover 26 open, as shown in FIG. 15. The primary cassette 72 of the DCS film 70 can be inserted into the first chamber 28. The secondary cassette 74 of the DCS film 70 can be inserted into the second chamber 30 such that each protrusion 44 is at least partially received in a respective one of the recesses 96 in the secondary cassette 74. It should be noted that the steps of inserting the primary and secondary cassettes 72, 74 can be performed in any order and can even be performed substantially simultaneously. If necessary, other components, such as the battery door 126 and the endcap 42 can be inserted, as shown in FIG. 16. Next, the back cover 26 and the main body 22 can be operatively engaged so as to form a light-tight film casing, as shown in FIGS. 17 and 18. The DCS film system 70 can be enclosed light-tightly therein. Because DCS film 70 provides two cassettes to protect the film, it will be appreciated that all of the above loading steps can conveniently be performed in the daylight.

FIG. 18 shows the completed camera 124, which is now ready to take pictures. Once all the pictures are taken, the primary and secondary cassettes can be removed from the camera, as shown in FIG. 19. The film in the primary cassette 72 can be processed. The secondary cassette 74, now empty, can be discarded.

Further, it will be appreciated that if a manufacturer or an end user tries to load regular DCS film system 2 (that is, DCS film without features in accordance with aspects of the invention, as shown in FIG. 1), the secondary cassette 8 will not property seat in the second chamber 30 due to interference with the protrusions 44. As a result, the back cover 26 of the camera 20 cannot be closed. In order to continue using the camera 20, DCS film 70 adapted in accordance with aspects of the invention must be purchased. Thus, a camera 20 configured in accordance with aspects of the invention can dictate the particular film system that is used in the camera. Someone wishing to reload the camera cannot circumvent this arrangement by trying to reuse an old secondary cassette because, as noted previously, it would have to be broken to get into it. Thus, a secondary cassette 74 configured in accordance with aspects of the invention in is in effect a single-use item.

Aspects of the invention can be applied to a variety of camera assemblies. While particularly suited for single-use cameras, embodiments of the invention are not limited to such cameras. Further, it will be understood that the invention is not limited to the specific details described herein, which are given by way of example only, and that various modifications and alterations are possible within the scope of the invention as defined in the following claims.

What is claimed is:

1. A camera comprising:
a main body supporting a taking lens and a closeable exposure aperture; the main body having a cartridge chamber and a film chamber disposed on opposite sides of the exposure aperture,
the film chamber being defined at least in part by a concave curved wall bounded by an upper end wall and a lower end wall, the film chamber being sized to receive a secondary cassette of a double cassette film system, wherein the film chamber includes a first protrusion extending into the film chamber from one of the concave curved wall, the upper end wall and the lower end wall; and
a back cover operatively engaging the main body to enclose the chambers light-tightly therein.

2. The camera of claim 1 wherein the first protrusion extends from one of the upper and lower walls.

3. The camera of claim 1 further including a second protrusion extending into the film chamber from one of the concave curved wall, the upper end wall and the lower end wall.

4. The camera of claim 3 wherein the first protrusion extends from the upper end wall and the second protrusion extends from the lower end wall.

5. The camera of claim 3 wherein the first and second protrusions are substantially identical.

6. The camera of claim 3 wherein at least one of size and shape of the first protrusion is different from the second protrusion.

7. The camera of claim 3 wherein the first and second protrusions are substantially vertically aligned.

8. The camera of claim 3 wherein the first and second protrusions are located in a right side region of the film chamber.

9. A double cassette film system comprising:
a primary cassette;
a secondary cassette having an exterior defined by an upper end wall, a lower end wall, and a curved middle wall, wherein the secondary cassette includes a first recess formed in the exterior of the secondary cassette;
photographic film, wherein a first portion of the photographic film is light-tightly housed within the primary cassette and a second portion of the photographic film is light-tightly housed within the secondary cassette, and wherein a third portion of the photographic film extends between the primary and secondary cassettes, the third portion of film being located between the first and second portions of film.

10. The film system of claim 9 wherein primary cassette is a 35 millimeter cassette.

11. The film system of claim 9 wherein the secondary cassette is formed by a first partial shell and a second partial shell.

12. The film system of claim 11 wherein the first and second partial shells are permanently coupled, whereby the secondary cassette must be broken in order to be opened.

13. The film system of claim 12 wherein the first and second partial shells are welded together.

14. The film system of claim 11 wherein the first and second partial shells are connected by lugs engaging respective openings.

15. The film system of claim 9 wherein the first recess is formed in one of the upper and lower end walls.

16. The film system of claim 9 further including a second recess formed in the exterior of the second cassette.

17. The film system of claim 16 wherein the first recess is formed in the upper end wall and the second recess is formed in the lower end wall.

18. The camera of claim 16 wherein the first and second recesses are substantially the same size.

19. The camera of claim 16 wherein the first and second recesses are substantially the same shape.

20. The camera of claim 16 wherein the first and second recesses are different in at least one of size and shape.

21. A camera system comprising:
a camera having a main body with a closeable exposure aperture, a cartridge chamber and a film chamber disposed on opposite sides of the aperture, the film chamber being defined at least in part by a concave curved wall bounded by an upper end wall and a lower end wall, the film chamber being sized to receive a secondary cassette of a double cassette film system, wherein the film chamber includes a first protrusion extending into the film chamber from one of the concave curved wall, the upper end wall and the lower end wall; and
a double cassette film system including a primary cassette; a secondary cassette having an exterior defined by an upper end wall, a lower end wall, and a curved middle wall, wherein the secondary cassette includes a first recess formed in the exterior of the secondary cassette; and
photographic film, wherein a first portion of the photographic film is light-tightly housed within the primary cassette and a second portion of the photographic film is light-tightly housed within the secondary cassette, and wherein a third portion of the photographic film extends between the primary and secondary cassettes, the third portion of film being located between the first and second portions of film,
the primary cassette being received in the cartridge chamber, and the secondary cassette being received in the film chamber such that at least a portion of the first protrusion extends into the first recess.

22. The camera system of claim 21 wherein the camera includes a back cover, wherein the back cover operatively engages the main body to enclose the double cassette film system light-tightly therein.

23. The camera system of claim 21 wherein the first protrusion extends from one of the upper and lower walls of the film chamber, and wherein the first recess is formed in a respective one of the upper and lower end wall of the secondary cassette.

24. The camera system of claim 21 further including:
a second protrusion extending into the film chamber from one of the concave curved wall of the film chamber, the upper end wall and the lower end wall; and
a second recess formed in the exterior of the secondary cassette, wherein at least a portion of the second protrusion extends into the second recess.

25. The camera system of claim 21 wherein the first protrusion extends from the upper end wall and the second protrusion extends from the lower end wall of the film chamber, and wherein the first recess is formed in the upper end wall and the second recess is formed in the lower end wall of the secondary cassette.

26. A method of making a film system comprising the steps of:
withdrawing a length of film from a film source;
forming a portion of the length of film into a roll, wherein a portion of the film extends from the roll; and
bringing together a first partial shell and a second partial shell around the roll of film so as to light-tightly enclose the film inside and so that the portion of film extends outside of the first and second partial shells, thereby forming a secondary cassette having an exterior, wherein a recess is formed in the exterior of the secondary cassette,
wherein the steps of withdrawing, forming and bringing together are performed in a dark environment.

27. The method of claim 26 further including the step of permanently coupling the first and second partial shells.

28. The method of claim 27 wherein the step of permanently coupling is performed by supersonic welding.

29. The method of claim 26 wherein the dark environment is a dark room.

30. The method of claim 26 wherein the withdrawn length of film has an end, wherein the forming step is performed by the steps of:
attaching the end of the length of film to a shaft;
rotating the shaft so that the film winds around the shaft in the form of a roll; and
separating the shaft and the film roll.

31. The method of claim 26 wherein the film source is a 35 millimeter film cartridge.

32. The method of claim 26 wherein the film source is a film pancake.

33. The method of claim 32 further including the step of cutting the length of film from the film pancake, the cut length of film having a trailing end.

34. The method of claim 33 further including the steps of:
providing a light-tight primary cassette, the primary cassette having an internal spool and a film slot;
inserting the trailing end of film into the primary cassette through the film slot; and
attaching the trailing end of film to the internal spool.

35. A method of loading film in a camera comprising the steps of:
providing a camera having a main body with a closeable exposure aperture, a cartridge chamber and a film chamber disposed on opposite sides of the aperture, the film chamber being defined at least in part by a concave curved wall bounded by an upper end wall and a lower end wall, the film chamber being sized to receive a secondary cassette of a double cassette film system, wherein the film chamber includes a first protrusion extending into the film chamber from one of the concave curved wall, the upper end wall and the lower end wall;
providing a double cassette film system including a primary cassette; a secondary cassette having an exterior defined by an upper end wall, a lower end wall, and a curved middle wall, wherein the secondary cassette includes a first recess formed in the exterior of the secondary cassette; and photographic film, wherein a first portion of the photographic film is light-tightly housed within the primary cassette and a second portion of the photographic film is light-tightly housed within the secondary cassette, and wherein a third portion of the photographic film extends between the primary and secondary cassettes, the third portion of film being located between the first and second portions of film;
inserting the primary cassette of the DCS film into the cartridge chamber; and
inserting the secondary cassette of the DCS film into the film chamber such that the first protrusion is at least partially received in the first recess in the secondary cassette.

36. The method of claim 35 wherein the steps of inserting the primary cassette and inserting the secondary cassette are performed substantially simultaneously.

37. The method of claim 35 wherein the step of inserting the primary cassette is performed prior to the step of inserting the secondary cassette.

38. The method of claim 35 wherein the step of inserting the secondary cassette is performed prior to the step of inserting the primary cassette.

39. The method of claim 35 wherein the camera includes a back cover and further including the step of operatively engaging the back cover and the main body so as to enclose the double cassette film system light-tightly therein.

40. The method of claim 35 wherein each of the providing and inserting steps is performed in normal light conditions.
